(19) United States
(12) Patent Application Publication
(10) Pub. No.: US 2011/0311305 A1
(43) Pub. Date: Dec. 22, 2011

(54) ELECTRIC ISOLATORS FOR COUPLINGS

(75) Inventors: Ronald Ralph Cairo, Greer, SC (US); Nicholas Simon Graham, Greenville, SC (US)

(73) Assignee: GENERAL ELECTRIC COMPANY, Schenectady, NY (US)

(21) Appl. No.: 12/818,486

(22) Filed: Jun. 18, 2010

(51) Int. Cl. F16D 1/033; F16D 1/02

(52) U.S. Cl. 403/337; 403/335

(57) ABSTRACT

A transfer device includes a first portion having a first portion flange and a second portion having a second portion flange. The device also includes one or more isolating members disposed at least partially within the second portion flange and at least partially between the first portion flange and the second portion flange, the one or more isolating members electrically isolating the first portion from the second portion. The device also includes a fastener passing through one of the one or more isolating members, the first portion flange and the second portion flange and holding the first portion flange and the second portion flange in a fixed relationship to one another.

### BACKGROUND OF THE INVENTION

The subject matter disclosed herein relates to couplings and, in particular, to electrical isolators used for couplings.

Many applications require that rotating shafts be coupled together. For example, generators are driven by industrial turbines to produce electricity. A load coupling is often used to connect the shafts of the generator and the turbine. The coupling is typically electrically insulated to prevent current traveling down the rotor shafts. If current is transmitted to the rotor of the turbine, there is a possibility of electrical arcing from the rotor to the bearing surfaces, which can cause damage and potentially failure of the bearings.

In more detail, in one class of couplings for rotating shafts, a drive portion of the coupling is coupled to a driving shaft by a group of circumferentially spaced fasteners. A driven portion of such a coupling is similarly coupled to a driven shaft. The two parts of the coupling are then coupled together by connecting bolts. During rotation, the driving shaft applies a force that is transmitted through the connecting bolts to the driven shaft.

Typically, the drive portion is electrically isolated from the driven portion by a spacer disposed between the two. The prevailing approach to providing electrical isolation is through the use of fiberglass reinforced epoxy (FG/Ep) spacer. The insulating assembly typically includes four elements: an insulating plate, bushings, washers and a pilot ring.

### BRIEF DESCRIPTION OF THE INVENTION

According to one aspect of the invention, a coupling that includes a first portion configured for connection to a first shaft and having a first portion flange and a second portion configured for connection to a second shaft and having a second portion flange. The coupling of this embodiment also includes one or more isolating members disposed at least partially within the second portion flange and at least partially between the first portion flange and the second portion flange and electrically isolating the first portion from the second portion. The coupling of this aspect also includes one or more connecting members passing through the one or more isolating members, the first portion flange and the second portion flange and holding the first portion flange and the second portion flange in a fixed relationship to one another

According to another aspect of the invention, a transfer device including a first portion having a first portion flange and a second portion having a second portion flange. The transfer device of this aspect also includes one or more isolating members disposed at least partially within the second portion flange and at least partially between the first portion flange and the second portion flange and electrically isolating the first portion from the second portion. The transfer device of this aspect also includes a fastener passing through one of the one or more isolating members, the first portion flange and the second portion flange and holding the first portion flange and the second portion flange in a fixed relationship to one another.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross sectional view of one half of a coupling according to one embodiment;

FIG. 2 is a cut-away side view of a connection assembly according to one embodiment;

FIG. 3 is a perspective view of one embodiment of an isolating member that may be used in a connection assembly;

FIG. 4 is a perspective view of another embodiment of an isolating member;

FIG. 5 is a perspective view of yet another embodiment of an isolating member;

FIG. 6 is a cut-away side view of a connection assembly that provides radial barriers to debris according to one embodiment; and

FIG. 7 is a cut-away side view of a connection assembly that provides radial barriers to debris according to another embodiment.

The detailed description explains embodiments of the invention, together with advantages and features, by way of example with reference to the drawings.

### DETAILED DESCRIPTION OF THE INVENTION

As described above, the prevailing approach to providing electrical isolation included fiberglass reinforced epoxy (FG/Ep) components. Although FG/Ep provides good isolation, experience and analysis have shown that FG/Ep may exhibit failure due to high stress (crushing of fiberglass). In addition, FG/Ep components may experience radial growth and deformation due to non-uniform properties (properties are dependent on direction of fiberglass reinforcement); may wear and degrade over time and have a low coefficient of friction (static =0.1) when in contact with steel which may result in low torque transmission through friction which can cause loading of connecting members in shear.

Accordingly, embodiments of the present invention may provide a more wear resistant and still electrically isolating material at the junction of a driving portion and a driven portion of a coupling. In particular, the material may be in the form of bushings formed of ceramic.

In addition, embodiments of the present invention may include radial barriers to debris liberation in the event of a fracture in or damage to the bushing. This may include providing recesses in one or both the drive and driven portions of the coupling. While the following description is directed to a load coupling, it shall be understood that the teachings herein may be applied to any coupling 100 that joins two rotating members, for example, one that transfers energy, movement or the like

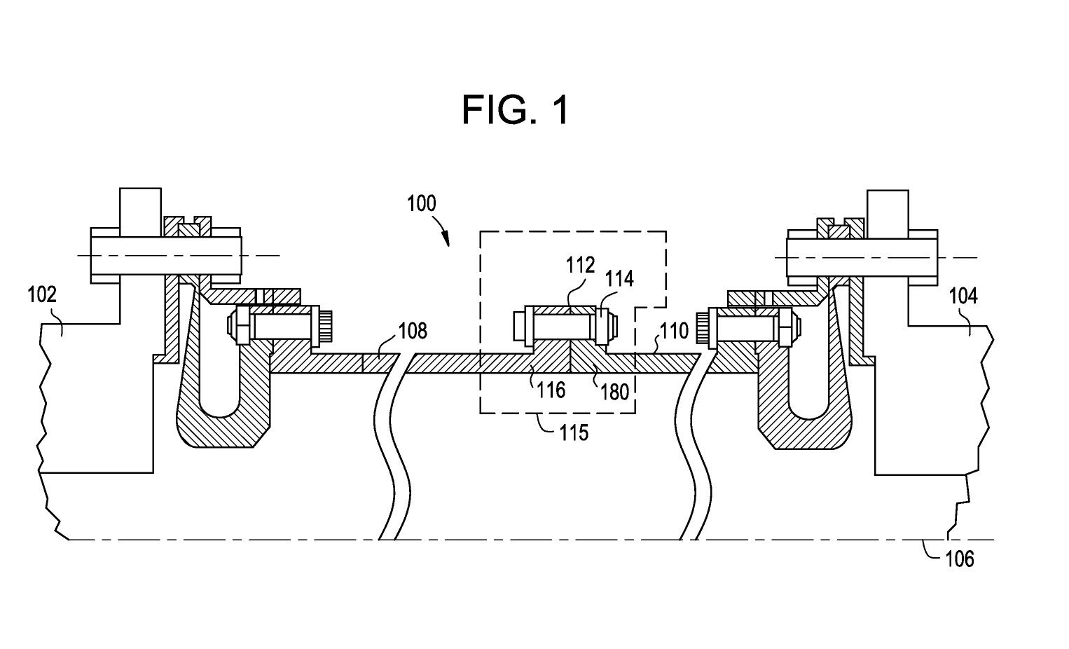

FIG. 1 is a cut-away side view of one half of a coupling 100 according to one embodiment. The coupling 100 joins a first shaft 102 to a second shaft 104. In one embodiment, the coupling 100 is a flexible load coupling and may provide a transfer in cases where the first shaft 102 and the second shaft 104 may become slightly off-axis from one another due to factors such as thermal expansion of the shafts. In operation, the coupling 100, the first shaft 102 and the second shaft 104 rotate generally around rotation axis 106.

The coupling 100 includes a first portion 108 coupled to the first shaft 102 and a second portion 110 coupled to the second shaft 104. The first portion 108 is coupled to the second portion 110 by one or more connection assemblies 115. Each connection assembly 115 may include a fastener 114 that holds a flange 116 of the first portion 108 to a flange 118 of the second portion 110. Of course, in one embodiment, the flange 116 of the first portion 108 could be held in a fixed position relative to the flange 118 of the second portion 110 by interference arrangements, interlocking arrangements, adhesive or other bonding arrangements.

In one embodiment, the first portion 108 is electrically isolated from the second portion 110. In this manner, the first shaft 102 is electrically isolated from the second shaft 104. In one embodiment, one or more isolating members 112 are disposed between the first portion 108 and the second portion 110 to electrically isolate them. In operation, the isolating members 112 transmit torque between the first portion 108 and the second portion 110 in addition to electrically isolating them from each other. Accordingly, in one embodiment, the isolating members 112 are formed of a material that is relatively stiff while in other embodiments, a high coefficient of friction is a feature.

Embodiments of the present invention include isolating members 112 formed of a ceramic material. The ceramic may exhibit high compressive strength, direction independent properties, high wear resistance and higher coefficient of friction than FG/Ep (i.e., static coefficient friction greater than or equal to about 0.22) when in contact with steel (higher torque transmission through friction which can prevent loading of bolts in shear). For example, the isolating members 112 may be formed of at least one of Alumina (Al₂O₃), Alumina-Silica, Alumina-Carbon-SiC, Alumina-Chromium oxide, Alumina-Calcium oxide, cordierite (2MgO—2Al₂O₃—5SiO₂), Mullite (Al₆Si₂O₁₃), Silicon carbide (SiC), Silicon nitride (Si₃N₄), Zirconia (ZrO₂), Zirconium-Silicate (ZrSiO₄) and Zirconia strengthened aluminas (ZrO₂—Y₂O₃, Al₂O₃—ZrO₂, ZrO₂—MgO, ZrO₂—Y₂O₃—CeO₂) and combinations including at least one of the foregoing. Of course, other materials may be utilized.

One concern that may exist with utilizing ceramic materials as the isolating members 112 include the fact that ceramics may be brittle and prone to fast-fracture raising the threat of debris or large pieces being liberated. In the case of a turbine, the debris may become foreign object debris to the critical rotating components (airfoils) with the potential for catastrophic unit damage. In one embodiment, such issues may be addressed by providing projections from or recesses within either or both the first portion 108 and the second portion 110 that offer radial barriers to debris liberation.

In FIG. 1, the connecting members 114 are shown as connecting the first portion 108 and the second portion 110 in a region outside an outer surface of both of these portions. Of course, the connecting members 114 may be located with the outer surface in one embodiment.

In the following description, the first portion 108 is referred to as a “driving” portion the second portion 110 is referred as a “driven” portion for the sake of convenience and clarity. It shall be understood that this is not meant as limiting and the first portion 108 could be referred to as a driven portion and the second portion 110 could be referred to as a driving portion.

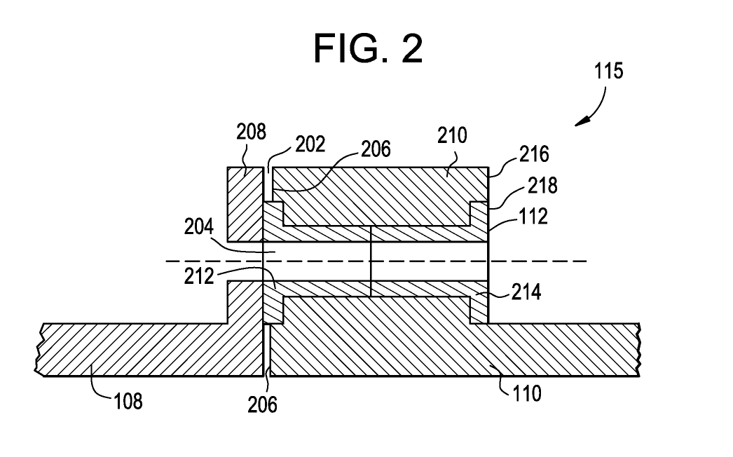

FIG. 2 is a cut-away side view of a connection assembly 115. The connection assembly 115 includes a driving flange 208 of the driving portion 108 and a driven flange 210 of the driven portion 110. In this example, the driven flange 210 includes isolating member 112 disposed therein. Of course, the isolating member 112 could be disposed within the driving flange 208 instead.

The isolating member 112 may include two or more portions. For example, the isolating member 112 may be divided into a first isolating member portion 212 and a second isolating member portion 214. Dividing the isolating member 112 into two or more portions may: provide discrete boundaries as crack arrestors should the isolating member 112 be over-stressed and fracture; facilitate installation in the adjoining flanges; and allow axial compliance during fastener (bolt) tightening to avoid axial over-stress or edge damage to the isolating member 112.

The isolating member 112 may extend beyond a first outer edge 206 of the driven flange 210 to create an air gap 202 between the driving portion 108 and the driven portion 110. The air gap 202 may be sized to ensure that an expected current cannot arc across it and electrically couple the driving portion 108 to the driven portion 110. The driven flange 210 may also include a second outer edge 216 opposite the first outer edge 206. The second outer edge may be flush with an end 218 of the isolating member 112. This may allow a bolt head or a nut coupled to a bolt to contain debris from escaping from the second outer edge 216 in the case of breakage of the isolating member 214. Further description of how debris may be contained at or near the first outer edge 206 is described in greater detail below.

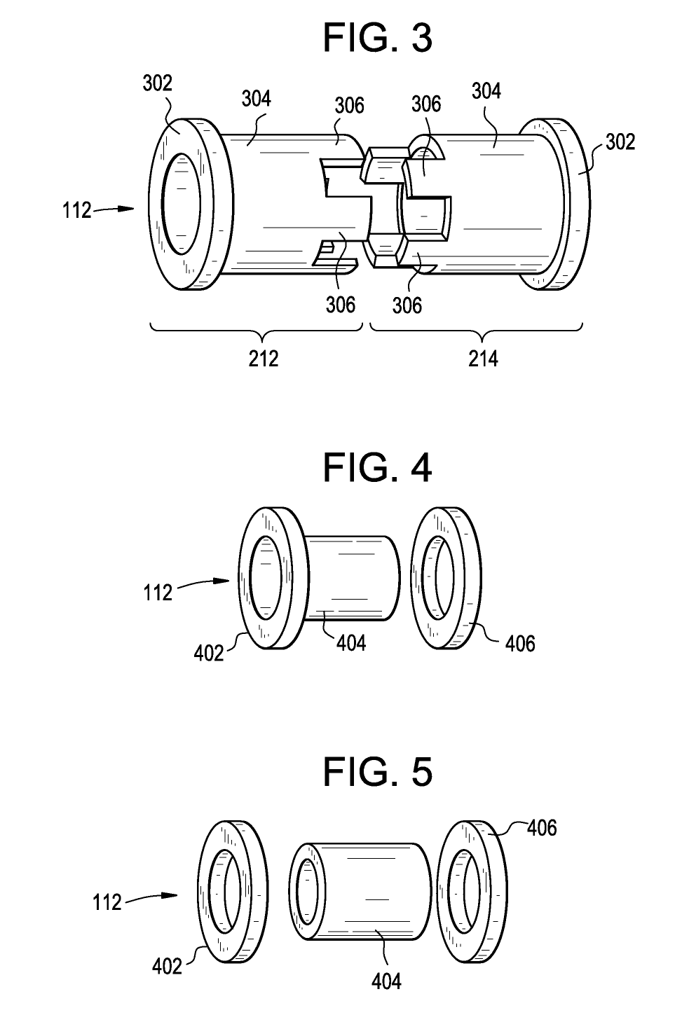

FIG. 3 is a perspective view of one embodiment of an isolating member 112. In this embodiment the isolating member 112 is a bushing. The isolating member 112 is divided into first isolating member portion 212 and second isolating member portion 214. Both the first isolating member portion 212 and the second isolating member portion 214 include ring portions 302. Coupled to the ring portions 302 are tube portions 304, the inner diameter of which defines the barrel 204 (FIG. 2) of the isolating member 112 through which a fastener may be inserted.

In this embodiment, the tube portions 304 include a castellated portion 306 with castellations 308 that mate with one another. That is, castellations 308 on the first isolating member portion 212 mate with castellations 308 on the second isolating member portion 214. The ring portions 302 may have a larger diameter than the tube portions 304 in one embodiment. Of course, the castellations 308 may be in form of triangular teeth or other shapes than those shown in FIG. 3

FIG. 4 is a perspective view of another embodiment of an isolating member 112. This embodiment includes a first combined portion 400. The first combined portion includes a first ring portion 402 coupled to a first tube portion 404. This embodiment includes a second ring portion 406 that is separable from the first tube portion 404 and may be, for example, in the form of a washer.

FIG. 5 shows a perspective view of yet another embodiment of an isolating member 112. In this embodiment, first ring portion 402 is separated from the first tube portion 404. Of course, the first tube portion 404 may be separated into multiple portions.

As discussed above, embodiments of the present invention may provide radial barriers formed by the driving portion or the driven portion to prevent or reduce debris liberation in the event that an isolating member cracks or otherwise fails. In particular, either or both of the driven portion or the driving portion may include projections from or recesses within the subject portion that offer radial barriers to debris liberation.

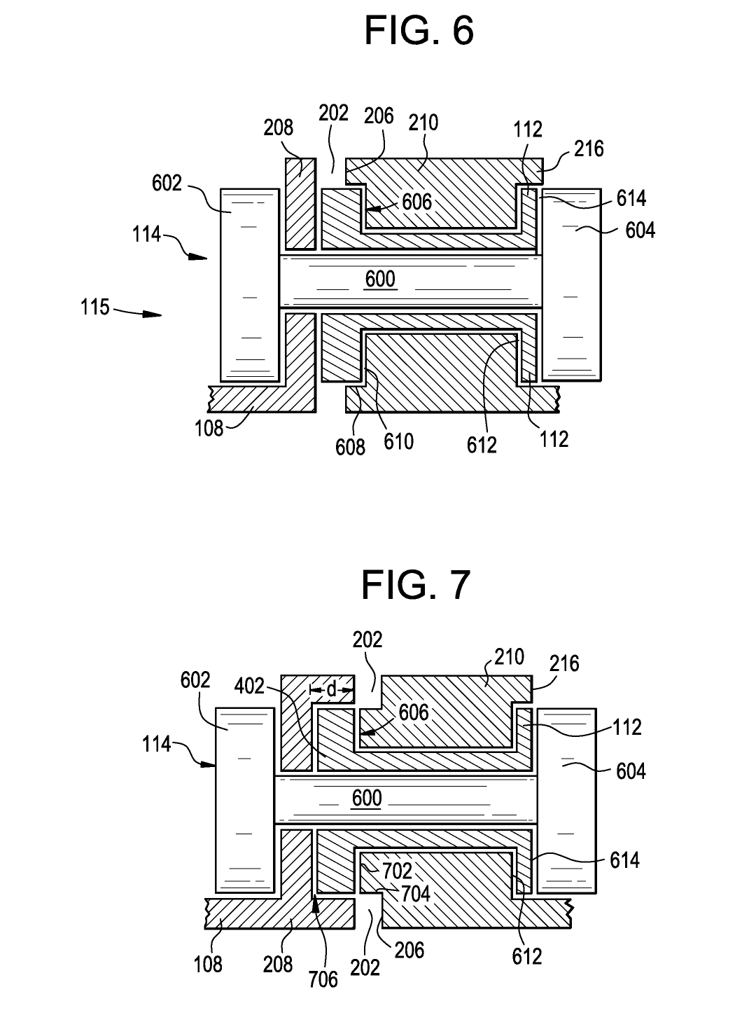

FIG. 6 is a cross sectional view of a connection assembly 115 (FIG. 1) that provides radial barriers to the debris that may be created in the event that the isolating member 112 breaks or is otherwise damaged. The isolating member 112 may be implemented, for example, as any of the embodiments shown in FIGS. 3-5

In FIG. 6, a connecting member 114 is implemented as a bolt 600 having a head 602. The bolt 600 may be coupled to a nut 604 to hold the driving flange 208 in a fixed relationship to the driven flange 210. The combination of the bolt 600 and the nut 604 forming connecting member 114 in this embodiment provide a compressive force holding the driving flange 208 and the driven flange 210 in a fixed relationship to one another. Additionally, the connecting member 114 may transfer torque from the driving flange 208 to the driven flange 210 during operation.

Typically, the connecting member 114, the driving flange 208 and the driven flange 210 are all formed of a conducting metal such as steel. Accordingly, the isolating member 112 electrically isolates the driving flange 208 from the driven flange 210 and the connecting member 114 from at least one of driving flange 208 and the driven flange 210. Electrically isolating the connecting member 114 from one of the driving flange 208 and the drive portion 210 ensures that the connecting member 114 does not provide an electrical connection between the two.

In this embodiment, the driven flange 210 includes a first recess 606 formed of interior walls 608 and 610. In particular, first interior wall 608 extends inwardly toward the center of the driven flange 210 and second interior wall 610 extends radially inward from the first interior wall 608. The first recess 606 may be formed as a counter bore in the driven flange 210 having a bole hole therein for receiving the connecting member 114. The first interior wall 608 may have a length selected such that a portion of the isolating member 112 extends beyond the first recess 606. The amount by which the isolating member 112 extends beyond the first recess 606 may define the width of the air gap 202 between the driving flange 208 and the driven flange 210.

The driven flange 210 may also include a second recess 612. The second recess may be formed such that an outer surface 614 of the isolating member 112 is flush with the second outer edge 216 of the driven flange 210.

In one embodiment, the nut 604 provides a barrier to debris liberation on the second outer edge 216 side of the driven flange 210. On the first outer edge 206 side of the driven flange 210, the first recess 606 and the driving flange 208 provide barriers to debris liberation.

FIG. 7 is a cross sectional view of an alternative embodiment of a connection assembly 115 (FIG. 1) that provides radial barriers to the debris that may be created in the event that the isolating member 112 breaks or is otherwise damaged. As in FIG. 7, the driven flange 210 may include a second recess 612. The second recess 612 may be formed such that an outer surface 614 of the isolating member 112 is flush with the second outer edge 216 of the driven flange 210. The nut 604 provides a barrier to debris liberation on the second outer edge 216 side of the driven flange 210.

In this embodiment, the driven flange 210 includes the first outer edge 206. A projection 703 formed by first extension 702 and projection edge 704 extends outwardly from the first outer edge 206. The projection 703 contacts the isolating member 112 when assembled. In this embodiment, debris liberation is limited by a driving portion recess 706 formed in the driving flange 208 that surrounds the isolating member 112. The driving portion recess 706 may have a depth d such that an air gap 202 may exist between the first outer edge 206 and the driving flange 208. In one embodiment, the depth of the driving portion recess 706 is the same as a width of the first ring portion 402 of the isolating member 112.

The above description refers to “driving” and “driven” portions for convenience. Of course, in any embodiment described above, the terms driving and driven may be reversed without departing from the scope of the invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A coupling comprising:
a first portion configured for connection to a first shaft and having a first portion flange;
a second portion configured for connection to a second shaft and having a second portion flange;
one or more isolating members disposed at least partially within the second portion flange and at least partially between the first portion flange and the second portion flange, the one or more isolating members electrically isolating the first portion from the second portion; and
one or more connecting members passing through the one or more isolating members, the first portion flange and the second portion flange and holding the first portion flange and the second portion flange in a fixed relationship to one another.

2. The coupling of claim 1, wherein the one or more isolating members are formed of a ceramic material.

3. The coupling of claim 2, wherein the ceramic material is formed at least partially of alumina or zirconia.

4. The coupling of claim 1, wherein the first portion is a driving portion and the second portion is a driven portion.

5. The coupling of claim 1, wherein the first portion is a driven portion and the second portion is a driving portion.

6. The coupling of claim 1, wherein the first shaft is an output turbine shaft and the second shaft is a generator shaft.

7. The coupling of claim 1, wherein the one or more isolating members are formed of a first isolating member portion and a second isolating member portion and wherein both the first isolating member portion and the second isolating member portion are between ends of the one or more connecting members.

8. The coupling of claim 1, wherein the one or more isolating members include a first ring portion, a second ring portion and a tube portion disposed between the first ring portion and the second ring portion.

9. The coupling of claim 8, wherein the tube portion is formed of a first tube portion coupled to the first ring portion and a second tube portion coupled to the second ring portion, the first tube portion being separable from the second tube portion.

10. The coupling of claim 1, wherein the one or more connecting members comprise a bolt having a head and a nut coupled to the bolt.

11. The coupling of claim 1, wherein the first portion is separated from the second portion by an air gap.

12. The coupling of claim 1, wherein the second portion includes a radial barrier surrounding at least a portion of one of the one or more isolating members.

13. The coupling of claim 12, wherein a recess in an outer surface of the second portion flange forms the radial barrier.

14. The coupling of claim 1, wherein the first portion includes a radial barrier surrounding at least a portion of the isolating member.

15. The coupling of claim 14, wherein a recess in an outer surface of the first portion flange forms the radial barrier.

16. The coupling of claim 1, wherein the one or more isolating members are formed of at least one of: Alumina, Alumina-Silica, Alumina-Carbon-Silicon Carbide, Alumina-Chromium Oxide, Alumina-Calcium Oxide, Cordierite, Mullite, Silicon Carbide, Silicon Nitride, Zirconia, Zirconium-Silicate and a Zirconia strengthened Alumina and combinations including at least one of the foregoing.

17. A transfer device comprising:
a first portion having a first portion flange;
a second portion having a second portion flange;
one or more isolating members disposed at least partially within the second portion flange and at least partially between the first portion flange and the second portion flange, the one or more isolating members electrically isolating the first portion from the second portion; and
a fastener passing through one of the one or more isolating members, the first portion flange and the second portion flange and holding the first portion flange and the second portion flange in a fixed relationship to one another.

18. The transfer device of claim 17, wherein the one or more isolating members are formed of ceramic.

19. The transfer device of claim 17, wherein the one or more isolating members are formed of a first isolating member portion and a second isolating member portion and wherein both the first isolating member portion and the second isolating member portion are between ends of the fasteners.

20. The transfer device of claim 17, wherein the one or more isolating members include a first ring portion, a second ring portion and a tube portion disposed between the first ring portion and the second ring portion.

21. The transfer device of claim 20, wherein the tube portion is formed of a first tube portion coupled to the first ring portion and a second tube portion coupled to the second ring portion, the first tube portion being separable from the second tube portion.

22. The transfer device of claim 17, wherein the one or more isolating members are formed of at least one of: Alumina, Alumina-Silica, Alumina-Carbon-Silicon Carbide, Alumina-Chromium Oxide, Alumina-Calcium Oxide, Cordierite, Mullite, Silicon Carbide, Silicon Nitride, Zirconia, Zirconium-Silicate and a Zirconia strengthened Alumina and combinations including at least one of the foregoing.
